(19) United States
(12) Patent Application Publication
(10) Pub. No.: US 2014/0075411 A1
(43) Pub. Date: Mar. 13, 2014

(54) Meta-Languages For Creating Integrated Business Applications

(71) Applicant: Newport Systems Corporation, Newport Beach, CA (US)

(72) Inventors: Nhan Diep, Reno, NV (US); Tyler Joel Kayser, Irvine, CA (US)

(21) Appl. No.: 14/019,725

(22) Filed: Sep. 6, 2013

Related U.S. Application Data
(60) Provisional application No. 61/698,344, filed on Sep. 7, 2012.

(51) Int. Cl. G06F 9/44; G06F 9/45

(52) U.S. Cl. CPC G06F 8/34; G06F 8/41
USPC 717/109

(57) ABSTRACT

The present inventive subject matter is drawn to apparatus, systems, configurations, and methods of automatically creating an enterprise software application that accesses at least one database system. In one aspect of this invention, a system for creating an enterprise software application is automatically configured to present a plurality of user interface (UI) selectable items, and receive manipulations of the plurality of UI selectable items; and configured to generate a meta-application that accesses a database but that is both database systems agnostic and platform agnostic, based on the received manipulations of the plurality of UI selectable items, and translate the meta-application to compilable code that is database systems specific.

This application claims the benefit of priority to U.S. Provisional Application No. 61/698,344, filed Sep. 7, 2012. These and all other referenced extrinsic materials are incorporated herein by reference in their entirety. Where a definition or use of a term in a reference that is incorporated by reference is inconsistent or contrary to the definition of that term provided herein, the definition of that term provided herein is deemed to be controlling.

### FIELD OF THE INVENTION

The present invention relates to methods and systems for creating enterprise software applications.

### BACKGROUND

The following description includes information that may be useful in understanding the present invention. It is not an admission that any of the information provided herein is prior art or relevant to the presently claimed invention, or that any publication specifically or implicitly referenced is prior art.

Many companies utilize enterprise software applications (e.g., accounting software, human resources software, etc.) to assist their internal operations. As used herein, the term “enterprise software applications” means applications that are capable of accessing multiple database systems, and communicating with other enterprise software applications. As each company has different needs and requirements, instead of acquiring off-the-shelf software packages, some companies opt to custom-build their own enterprise software applications.

However, custom-building an enterprise software application can be expensive and labor-intensive. The company has to either employ or hire qualified and knowledgeable programmer to generate the enterprise software application. To make things more complicated, these enterprise software applications are created to access a specific set of database systems (e.g., Oracle® database systems, SAP® database systems, Access® database systems, etc.), and to run on a specific platform (e.g., Windows® operating systems, Unix® operating systems, Linux® operating systems, etc.). When the company decides to switch from one database system to another (to switch from one platform to another), the enterprise software application will have to be re-written or at least modified in order to interface with the new database system or run on the new platform.

Efforts have been made over the years to simplify the steps of generating and modifying of enterprise software applications. For example, the online article (http://blogjamesjones.name/2010/02/repository-pattern.html) discloses using object oriented languages such as Java and C++ to separate the programming codes that define the business logic of the software application from the programming codes that deal with the implementation details for accessing different database systems. U.S. patent publication 2011/0167403 to French et al. titled “Methods for Platform-Agnostic Definitions and Implementations of Applications”, filed Dec. 6, 2010, and disclosed a system and method that provides platform-agnostic definition and implementation of web and native applications.

In addition, commercial software packages, such as Adobe®'s Dreamweaver®, Apple®'s Interface Builder, and Microsoft® Visual Studio®, provide graphical user interfaces for automatically generating portions of the programming code needed to create enterprise level software application. These and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

Although the tools discloses in the above references have simplified the process for creating and/or editing software applications, they still require a lot of manual editing and writing of programming code, which is usually time-consuming and prone to errors. Therefore, there is still a need for a system for efficiently creating custom-build enterprise software applications.

All publications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

### SUMMARY OF THE INVENTION

The present inventive subject matter is drawn to apparatus, systems, configurations, and methods of automatically creating an enterprise software application that accesses at least one database system. In one aspect of this invention, a method of creating such an enterprise software application is presented.

In some embodiments, the method of creating an enterprise software application includes a step of providing a graphical user interface (GUI) to a user via a display. The GUI includes several user interface (UI) selectable items (such as drop down menu, buttons, etc.). The method also includes a step of manipulating the UI selectable items on the GUI to generate a meta-application. In some embodiments, the meta-application represents an enterprise software application that accesses a database. Unlike a compilable software application, the meta-application is both database systems agnostic and platform agnostic, meaning it is not tied to any particular database system or computer platform (including server hardware and operating system). The method also includes a step of translating the meta-application to compilable code that is database systems specific.

In some embodiments, the plurality of UI selectable items comprises a menu for receiving a selection of an event, a menu for receiving a selection of an action item, and a UI selectable item for making an association between the event and the action item.

In some embodiments, the step of manipulating comprises selecting one of the pluralities of UI selectable items. In other embodiments, the step of manipulating comprises selecting an initial location on the GUI for one of the plurality of UI selectable items. In yet other embodiments, the step of manipulating comprises moving the UI selectable item from the initial location to a different location on the GUI.

In some embodiments, the step of generating the meta-application includes a step of defining a business logic solely based on the manipulations of the UI selectable items, and a step of expressing the business logic in a meta-language.

Also in other embodiments, the step of translating the meta-application comprises receiving information indicating a specific database system. In some embodiments, the compilable code is translated without compiling the meta-language into an object code. The compilable code is a first compilable code that is specific to a first database system, in some embodiments. In other embodiments, the method further comprises translating the meta-application into a second compilable code that is specific to a second different database system.

The compilable code may also direct a set of database actions, in some embodiments. In other embodiments, the set of database actions comprises inserting new data into a database system. In yet other embodiments, the set of database actions comprises retrieving data from a database system and performing a calculation on the retrieved data.

In some embodiments, the method of creating an enterprise software application further includes compiling the translated code into an object code.

In another aspect of the invention, a system for creating an enterprise software application is presented. In some embodiments, the system for creating an enterprise software application includes a GUI configured to present a plurality of UI selectable items through a display, and to receive manipulations of the plurality of UI selectable items. In some embodiments, the system for creating an enterprise software application further includes an application engine configured to generate a meta-application, based on the received manipulations of the plurality of UI selectable items, that accesses a database but that is both database systems and platform agnostic. In other embodiments, the application engine may also translate the meta-application to compilable code that is database systems specific. In some embodiments, the application engine is further configured to generate the meta-application by defining a business logic solely based on the manipulations of the UI selectable items and expressing the business logic in a meta-language.

In some embodiments, the compilable code is translated without compiling the meta-language into an object code. In other embodiments, the compilable code is a first compilable code that is specific to a first database system, wherein the application engine is further configured to translate the meta-application into a second compilable code that is specific to a second different database system. In yet other embodiments, the compilable code is a first compilable code that is specific to a first platform, wherein the application engine is further configured to translate the meta-application into a second compilable code that is specific to a second different platform. The compilable code may also direct a set of database actions in some embodiments.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

FIG. 1 illustrates an example computing environment in which a system for creating an enterprise software application that accesses at least one database is presented.

FIG. 2 illustrates an example application engine of some embodiments.

FIG. 3 illustrates a process for creating an enterprise software application according to a preferred embodiment.

FIG. 4 illustrates an example of the ability of a user to link different screen/pages of the software application using source events and target actions model.

FIG. 5A illustrates an example graphical user interface of a template design screen as provided by a system for creating an enterprise software application according to a preferred embodiment.

FIG. 5B illustrates an example graphical user interface of a grid design screen as provided by a system for creating an enterprise software application according to a preferred embodiment.

FIG. 5C illustrates an example graphical user interface of a form design screen as provided by a system for creating an enterprise software application according to a preferred embodiment.

FIG. 5D illustrates an example of a graphical user interface of a graph design screen as provided by a system for creating an enterprise software application according to a preferred embodiment.

FIG. 6 illustrates an example database system connection screen of some embodiments.

### DETAILED DESCRIPTION

It should be noted that any language directed to a computer should be read to include any suitable combination of computing devices, including servers, interfaces, systems, databases, agents, peers, engines, modules, controllers, or other types of computing devices operating individually or collectively. One should appreciate the computing devices comprise a processor configured to execute software instructions stored on a tangible, non-transitory computer readable storage medium (e.g., hard drive, solid state drive, RAM, flash, ROM, etc.). The software instructions preferably configure the computing device to provide the roles, responsibilities, or other functionality as discussed below with respect to the disclosed apparatus. In especially preferred embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges preferably are conducted over a packet-switched network, the Internet, LAN, WAN, VPN, or other type of packet switched network.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

Unless the context dictates the contrary, all ranges set forth herein should be interpreted as being inclusive of their endpoints, and open-ended ranges should be interpreted to include commercially practical values. Similarly, all lists of values should be considered as inclusive of intermediate values unless the context indicates the contrary.

The present inventive subject matter is drawn to apparatus, systems, configurations, and methods of automatically creating an enterprise software application that accesses at least one database system. In some embodiments, a system is configured to automatically create an enterprise software application that accesses at least one database system. It is noted that the term “database system” is used euphemistically herein to describe any type of system that organizes and stores data. Examples of such database systems include Microsoft® Excel®, Microsoft® Access®, Oracle® database management systems, SAP® database management system, etc.

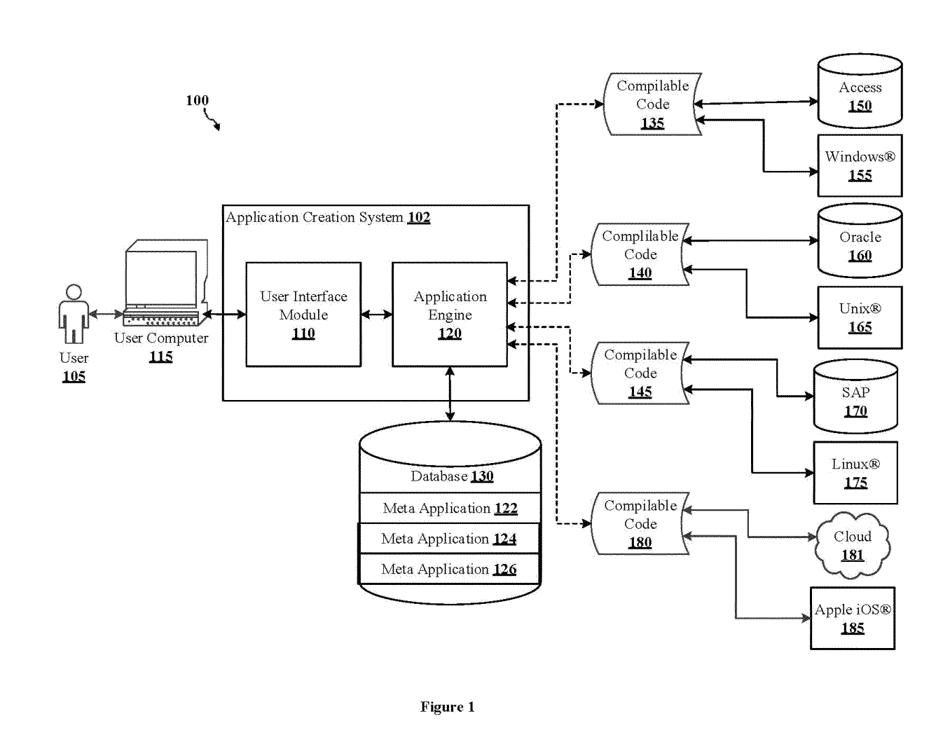

FIG. 1 illustrates an example computing environment in which an application creation system interacts with user computers and a database to produce different enterprise software applications each of which accesses at least one database system. As shown, the application creation system 102 includes a user interface module 110 and an application engine 120. In some embodiments, the user interface module 110 and the application engine 120 are implemented as software modules that are executable by at least one processing unit (e.g., a processor, a processing core) of a computing device. In some embodiments, the application creation system 102 may be communicatively coupled with a user computer 115 and a database 130.

In some embodiments, the user computer 115 may be operated by a business user 105. In these embodiments, the user 105 may want build an enterprise software application for a specific business purpose. The user 105 may be a non-technical person and have no knowledge of software programming or development. Thus, the user 105 may utilize the user computer 115 to interface with the application creation system 102.

The user computer 115 may communicate with the application creation system 102 over a network. In some embodiments, the user computer 115 may communicate with the user interface module 110. In these embodiments, the user 105 may utilize the user computer 115 to communicate the user's 105 manipulations to the user interface module 110. The user computer 115 may be directly integrated with the application creation system 102, or may be connected over a Local Area Network (LAN.) In these embodiments, the application creation system 102 and the user computer 115 may be setup in an internal network of a company. In other embodiments, the user computer 115 may be connected to the application creation system 102 over a Wide Area Network (WAN) or the Internet.

In some embodiments, the user interface module 110 is configured to present a graphical user interface (GUI) through a display of the user computer 115 to interact with the user 105. The GUI presented by the user interface module 110 includes several user interface (UI) selectable items such as icons, buttons, menus, etc. Some of the UI selectable items displayed on the GUI represents different components of an enterprise software application. For example, some of the UI selectable items represent different database systems and different components (e.g., records, cells, etc.) of the database systems, some of the UI selectable items represent different interface elements of the enterprise software application (e.g., buttons, input text fields, graphs, grids, etc.), some of the UI selectable items represent different processing and/or database actions (collectively referred to as “actions” herein), and some of the UI selectable items represent different human interactions with the enterprise software applications (also referred to as “events” herein). A database action is defined herein to describe any action that interacts with a database system. Examples of database actions include retrieving data from a database system, inserting data to a database system, and manipulating data in a database system. In addition, it is noted that an enterprise software applications would have an interface (e.g., a GUI) for interacting with a human. As such, human interactions with the enterprise software applications include any action that a human can perform to provide an input for a software application via any input devices, such as a mouse, a keyboard, a touch-sensitive device, etc via the interface elements. Examples of human interactions with the enterprise software include a clicking event, a typing event, a dragging event, etc.

In addition, the GUI can include a menu (e.g., drop down menu, pop-up menu, etc.) for selecting a human interaction with the enterprise software application, a menu (e.g., drop down menu, pop-up menu, etc.) for selecting an computer operation (e.g., a database action), and a tool for defining an association between a specific human interaction with the software and a specific computer operation.

In some embodiments, the user 105 can manipulate any one of the UI selectable items using an input device such as a mouse, a keyboard, and/or a touch-sensitive input device. Through these manipulations of the UI selectable items, the user 105 can define the business logic and the look and feel of the user interface of the software application. In some of these embodiments, the GUI of the application creation system 102 includes one or more display areas that represent the user interface of the enterprise software application. As such, user 105 can select any one or more of the UI selectable items that represent different interface elements, and place them onto the display area (i.e., through a drag and drop action) to define the user interface of the enterprise software application. In addition to selecting the initial location for the interface elements on the user interface of the enterprise software application, the user 105 can also move the interface elements from the initial location to a different location on the GUI of the enterprise software application through for example, drag-and-drop operation on the display area. In some embodiments, the user 105 can also select a UI tool of the GUI to define an association between two or more UI selectable items (e.g., to associate a user interaction on the GUI of the enterprise software application with an action of the enterprise software application).

Thus, through these manipulations of the UI selectable items on the GUI, the user 105 can define business logic and the look and feel of the interface for the enterprise software application without writing and/or editing any programming code. Preferably, the GUI is designed in such a way that even a person (e.g. the user 105) without knowledge of any programming language can generate the business logic for the enterprise software application.

In some embodiments, the application engine 120 may generate one or more meta-applications 122, 124, 126, based on the user's 105 manipulations of the UI selectable items. In some of these embodiments, the meta-application includes logic that directs a set of business work flows that involves interactions with one or more database systems. As mentioned above, the interactions with database systems can include retrieving data from the database, inserting data into the database, and manipulating data in the database. For example, through the GUI presented by the user interface module 110, the user 105 can define business logic and user interface for an enterprise accounting software application that takes sales figures, cost figures, and automatically generates quarterly reports for profits and losses.

One major distinction between the meta-application and an enterprise software application is that the meta-application is both database systems agnostic and platform agnostic. That is, the meta-application only includes the high-level business logic of accessing data in a fictitious database system but does not have the knowledge or implementation details of accessing a specific database system. In addition, the meta-application does not have the implementation details of executing the high-level business logic on any one of the computer platform, such as Windows® operating system, Unix® operating system, Macintosh® operating system, Linux® operating system, etc.

In some embodiments, the meta-application can be expressed using a meta-language (e.g., pseudo code) that is non-compilable into object codes. In some of these embodiments, the meta-application can be stored in a non-transitory storage medium such as hard drive, memory, or an optical disc (e.g., CD, DVD, etc.). The application engine 120 can then translate the meta-application into one or more compilable code (e.g., C++, Java®, etc.) that is both database systems specific and platform specific. That is, the compilable code includes, in addition to the business logic, the implementation detail for accessing one or more specific database system and for running on a specific computer platform.

Additionally, the application engine 120 may translate the one or more meta-applications (122, 124, or 126) to one or more set of compilable code (135, 140, 145, or 180.) In some embodiments, the one or more set of compilable code (135, 140, 145, or 180) are specifically configured to access at least one database systems (150, 160, 170, or 180) and may be operating and executing on a plurality of specific computer platform (155, 165, 175, or 185.) The database systems 150, 160, 170, 180 and the specific computer platforms (155, 165, 175, or 185) may be connected and accessible to the application engine 120 over a network. As shown in FIG. 1, the application engine 115 has translated the meta-application 122 into three different sets of compilable code (135, 140, 145, or 180.) Each compilable code (135, 140, 145, or 180) can be compiled into an object code to be run on a specific computer platform. In addition, each compilable code (135, 140, 145, or 180) is designed to direct a computer system to a specific database system. For example, compilable code 135 is designed to run on a computer system 155 with Windows® operating system, and directs the computer system to access data from an Access® database system 150. Compilable code 140 is designed to run on a computer system with Unix® operating system 165, and directs the computer system to access data from an Oracle® database management system 160. Compilable code 145 is designed to run on a computer system with Linux® operating system 175, and directs the computer system to access data from a SAP® database management system 170. Compilable code 180 is designed to run on a computer system with Apple iOS® operating system 185, and directs the computer system to access data from a Cloud database management system 181 that typically runs on a cloud computing platform.

The different sets of compilable code and/or their corresponding object code can be stored in any non-transitory storage medium. For example, the object code can be stored in the hard drive or memory of a computing system so that it can be loaded and executed by the processing units of the computing system to interact with users and perform operations for a company. In addition, the code can also be stored on an optical disc or any other portable non-transitory storage devices (e.g., USB jump drive, etc.) for transporting to any other computing devices.

In some of the embodiments, the database 130 may be configured to store one or more meta-applications (122, 124, or 126.) As mentioned, the application engine 120 may generate the one or more meta-applications (122, 124, or 126), and may also store the one or more meta-applications (122, 124, or 126) in the database 130. Upon the user's initiation, the application engine 120 may also translate one or more of the meta-applications (122, 124, or 126) into one or more different sets of compilable code (135, 140, 145, or 180.)

In some embodiments, the database 130 may be a permanent data storage such as a hard drive, a flash memory, etc. In other embodiments, the database 130 may be partially or totally setup separately from the application creation system 102, and may be communicatively coupled with the application creation system 102 over a network (e.g., a Local Area Network (LAN), a Wide Area Network (WAN), the Internet, etc.).

In some embodiments, the application creation system 102 may be implemented as computer software that is installed on a computer system operated by a business end-user. In other embodiments, the application creation system 102 may also include a World Wide Web (WWW) Server, through which the business user may access the service(s) provided by the application creation system 102 over the Internet. In yet other embodiments, the application creation system 102 may be implemented as a WWW Application, which the business user may access using a WWW Browser over the Internet.

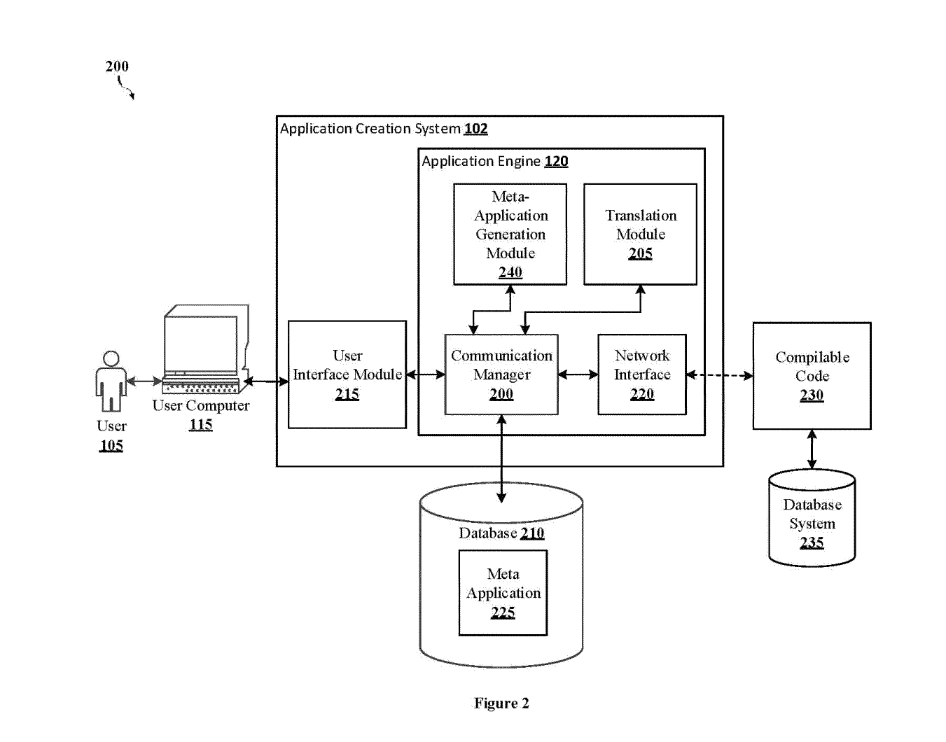

FIG. 2 illustrates an example application engine of some embodiments. As shown, the application engine 120 may include a communication manager 200, a meta-application generation module 240, a translation module 205, and a network interface 220. In some embodiments, the communication manager 200, the meta-application generation module 240, the translation module 205, and the network interface 220 may be implemented as software modules that can be executed by at least one processing unit (e.g., a processor, a processing core, etc.) of the application creation system 102 to perform different functions.

As shown, the communication manager 200 may also be communicatively coupled with a user interface module 215. In some embodiments, the communication manager 200 may instruct the user interface module 215 to provide a GUI through which the user 105 who uses the user computer 115 may interact with the application creation system 102. The communication manager 200 may receive the user's 105 manipulations of the UI selectable items and other user commands through the user interface module 215.

As shown, the communication manager 200 is communicatively coupled with a database 210. As mentioned, the database 210 in some embodiments may be integrated with the same set of devices on which the communication manager 200 is installed. In other embodiments, the database 210 may be physically removed from the communication manager 200, and the communication manager 200 may communicate with the database 210 over a network. (e.g. a LAN, a WAN, the Internet, etc.)

In some embodiments, the communication manager 200 will interact with the database 210 to create or modify a meta-application 225 and store it in the database 210. Further, the communication manager 200 may interact with the database 210 to translate the meta-application 225 stored in the database 210 into compilable code 230. Further, the communication manager 200 will utilize the network interface 220 to deploy the compilable code 230 on specific computer platforms, in other embodiments. In some embodiments, the compilable code 230 may connect to at least one database system 235.

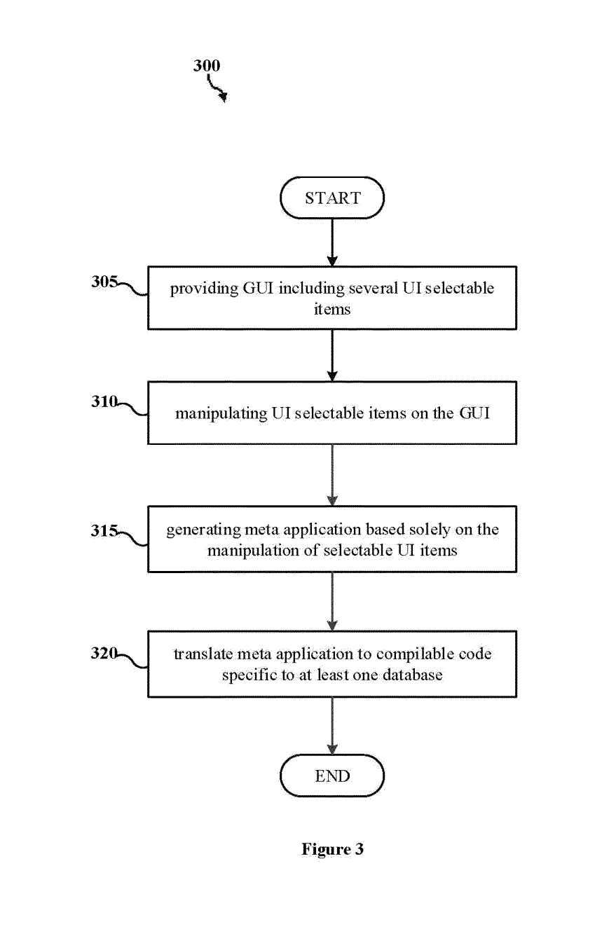

FIG. 3 outlines a preferred embodiment of a process for creating software applications that access at least one database system. The process 300 will now be described by reference to FIG. 2. Upon the user 105 making inquiries of the application creation system 102 regarding the design and construction of a business specific software application through the user computer 115, the user 105 may be presented with a GUI including several UI selectable items, in step 305.

The user 105 may then proceed to make a series of manipulations to the set of UI selectable items presented through the GUI on a display of the user computer 115, as in step 310. In some embodiments, one set of UI items may be give the user 105 the ability to define a data schema which the software application will consume. In these embodiments, the user 105 may have the ability to define the foundation of the data layer of the software application by authoring the collection of tables and columns of data expected to be available for consumption by the software application. For example, the user 105 may specify that the enterprise software application will have access to data tables such as a customer information table, product table, order table, payment table, etc. The user 105 may design the customer information table to include data about the potential customers of a business. Examples of the customer information that may be included in such a table are the customer name, address, contact telephone and fax, etc. Examples of information that may be included in a product table include the type or category of the product, quantity available, description, price, etc. Also, examples of the type of information that may be included in an order table include the name and type of product being ordered, price, ship date, quantity ordered, etc. Finally, examples of information that may be required in a payment table include type of payment (e.g. cash, check, credit card) total amount paid, date paid, etc.

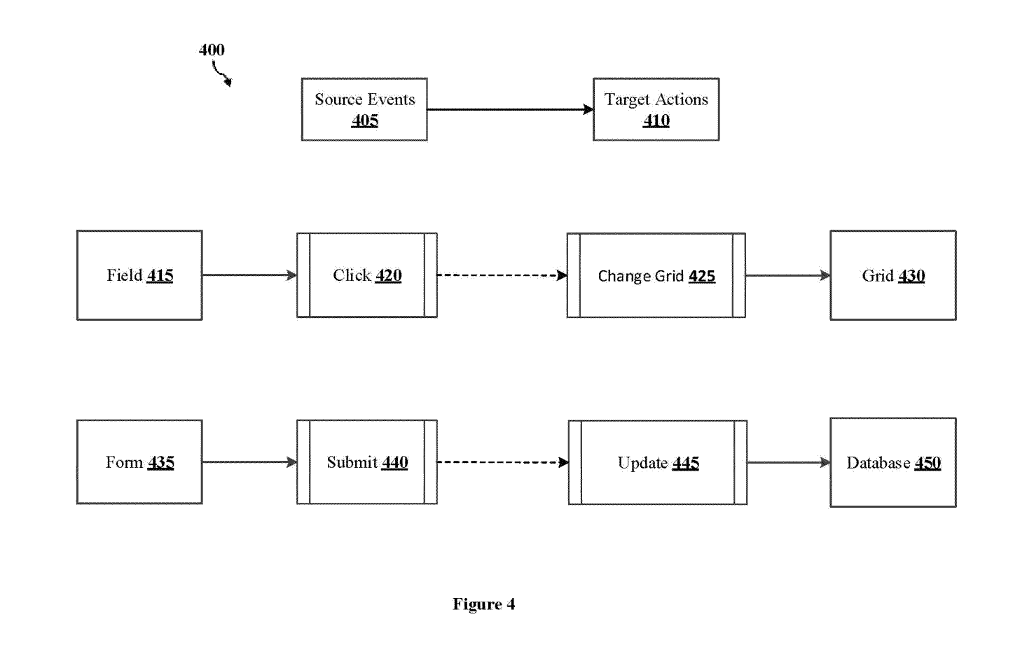

Another category of manipulations the user 105 may be able to conduct in some embodiments is related to the design of the business flow of the application under construction. FIG. 4, illustrates an example of how the user 105 may be able to link different screen or pages of the application being designed through source events and target actions model. As shown, the source events 405 trigger the business flow of the application in that they initiate the execution of target events. For example, the user 105 may design a field 415 on a given page or screen, and attach a mouse click event 420 to that field 415. Thereupon, during the application runtime, any mouse click on the field 415 will be translated into the execution of a given target action. The field 415 may be a label box, text field box, select list box, etc. In this example, the field 415 is displayed within a grid screen. Thus, a change grid action 425 is executed when the user of the application clicks the field 415 at runtime. As shown, the change grid action 425 will present a grid screen 430 to the user of the application at runtime.

Another example of a business flow is illustrated by FIG. 4. This example involves the submit source event 440 of a form 435 of the application at runtime. Accordingly, upon the submission of the form 435, an update target action 445 is set to execute on the records of a database system 450 that is connected to the application at runtime. For example, a form that displays personal information of a user of the application at runtime (e.g. first name, last name, address info, etc.) may provide a submit button which may be linked to the submit event on this form. When the user of the application clicks the submit button, the user's personal information may be updated in the corresponding database system, which may be connected to the application at runtime, as will be discussed in further details below.

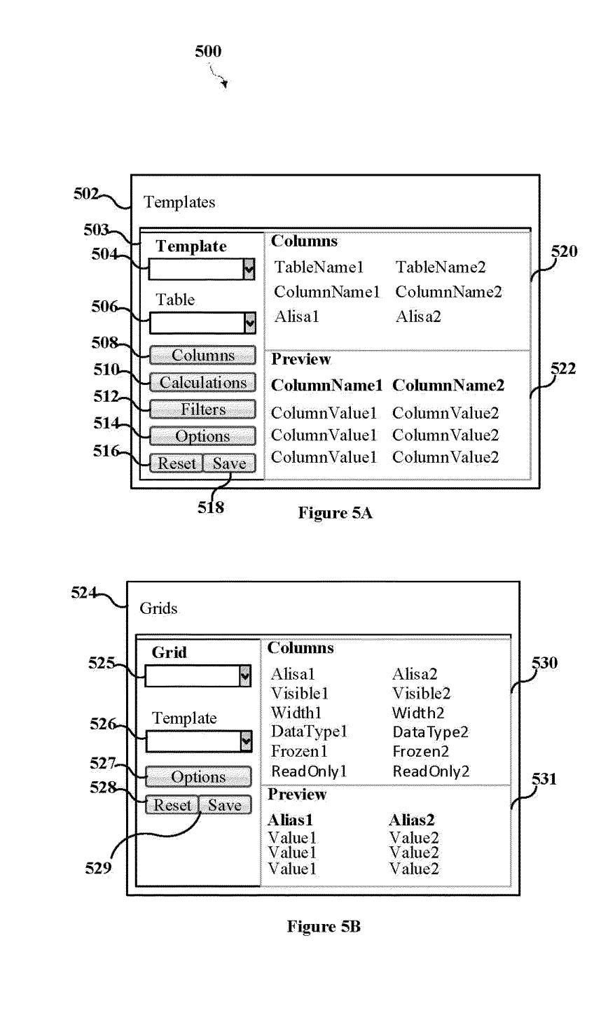

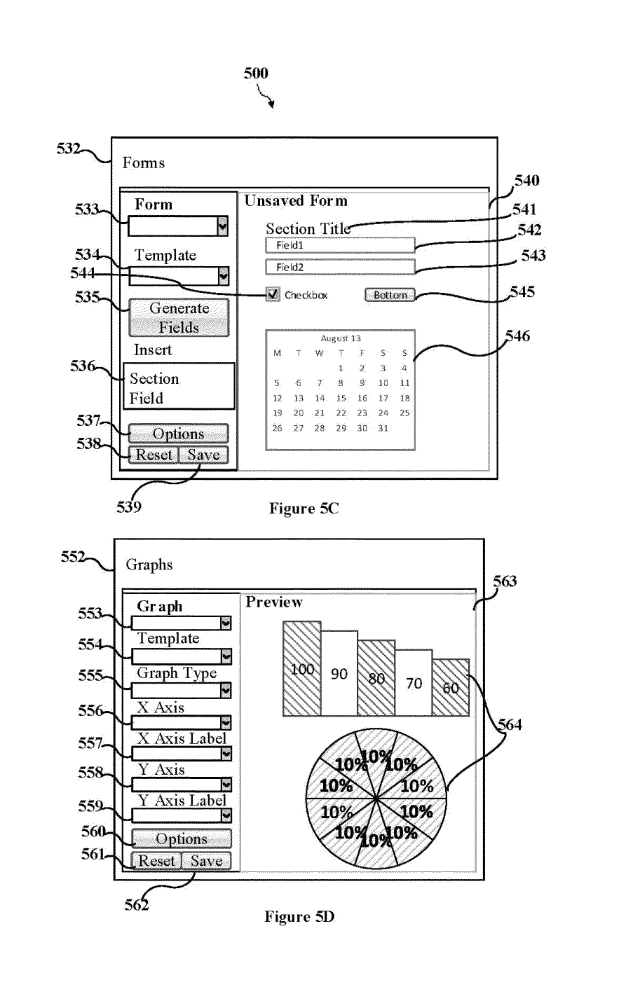

Another category of user 105 manipulations is related to the design of pages containing subsets of data of the already defined data schema, to be used by various presentation layers. Such pages may be called “templates.” FIG. 5A, illustrates an example template design screen of some embodiments. As mentioned, the user 105 will be able to interact with the template design screen 502 through the user computer 115, and the template design screen 502 may be made available by the user interface module 215. As shown, the template design screen 502 include a command menu 503, which may include a template selection drop box 504, a table selection drop box 506, a columns button 508, a calculations button 510, a filters button 512, an options button 514, a reset button 516, and a save button 518. The template design screen 502 also include a columns preview panel 522 and a template preview panel 522.

In some embodiments, the user 105 may select a template to edit or create by selecting an item from the template selection drop box 504. The user may link a new schema table, or select an existing one that already linked to the selected template, by selecting a table from the table selection drop box 506. The user 105 may then proceed to display the columns of the selected table, which are desired to be displayed on the selected template, by clicking the columns button 508. The user 105 may also utilize many options provided by the template design screen 502, by clicking the calculations button 510 to display certain value fields calculated at runtime within the selected template. The user 105 may also utilize the filters button 512 to create one ore more data filters of the set of records provided by the selected table, based on any desired criteria. Further, the user 105 may click the options button 514 to manipulate the display settings of the set of records selected by the current template. In some embodiments, the user 105 may select certain columns of the selected table to be displayed on the selected template by clicking on the desired columns displayed in the columns selection panel 520. Thereupon, a preview of the selected template will be generated and presented on the preview panel 522, which may be based on the user's 105 most recent manipulations.

At the conclusion of the user's 105 edits to the selected template, the user 105 may have the option to erase some or all of the unsaved manipulations to the selected template by clicking the reset button 516, or save all work completed for the current template by clicking the save button 518.

In some embodiments, the user 105 may then turn to use one or more of the created templates to provide the data to be display and/or used on a grid page. Thus, the user may use a grid design screen 524 to begin a design and construction effort. FIG. 5B, illustrates the grid design screen 524 according to some embodiments. The grid design screen 524 as shown includes a left menu panel that comprises a grid selection drop box 525, a template selection drop box 526, an options button 527, a reset button 528, and a save button 529. The grid design screen 524 also includes a column selection panel 530 and a preview panel 531.

In some embodiments, the user 105 may create a new grid or choose an existing grid to edit, using the grid selection drop box 525. The user 105 may also use the template selection drop box 526 to set the template which will contain the data fields to be displayed by the selected grid. Further, the user 105 may use the options button 527 to explore further options related to the display of the data fields of the selected template or any other presentation related options, which may be provided by the system. For example, clicking the options button 527 may cause a pop-up menu to be presented, which may give the user 105 the ability to set font attributes to the different column fields presented by the selected grid. The menu may also give the user 105 the ability to define the page layout of the selected grid (e.g. margins, orientation, size of page, column width, etc). Further, the menu may give the user 105 the ability to set color orientation of the different field columns presented by the selected grid, or to the grid as a whole (e.g. foreground color, background color, highlighting or different areas, etc.) The user 105 may also utilize the column selection panel 530 to select the data columns to be displayed within the selected grid, by clicking on the aliases corresponding to each of the columns. The preview panel 531 may in some embodiments reflect the user's 105 column selections, by displaying a preview of the selected set of data columns in the same format which will be displayed by the application at runtime.

As described with regards to the template design screen 502, when the user 105 conclude design efforts of the selected grid, the user 105 may have the option to erase some or all of the unsaved manipulations to the selected grid by clicking the reset button 528, or save all work completed for the current grid by clicking the save button 529.

In other embodiments, the user 105 may choose to design an application form. FIG. 5C, illustrate an example form design screen 532, which the user 105 may utilize to design an application form. As shown, the form design screen 532 includes a form selection drop box 533, a template selection drop box 534, a generate fields button 535, a field selection box 536, an options button 537, a reset button 538, and a save button 539. The form design screen 532 also includes an unsaved form panel 540, which includes the already generated form fields, such as a label 541, text fields 542, 543, a checkbox 544, a button 545, and a calendar control 546.

In some embodiments, the user 105 may create a new form, or select an existing form to edit, using the form selection drop box 533. Upon selecting a form, the user 105 may then choose a template to provide the data sources of the different potential fields of the selected form, using the template selection drop box 534. The user 105 may then proceed to design the form by choosing one or more fields to be displayed by the form. The user 105 may use the field selection box 536 to choose form fields, such as text fields, labels, buttons, etc. Upon selecting one or more field types from the field selection box 536, the user 105 may click the generate fields button 535 for the selected field(s) to display in the unsaved form panel 540. At the conclusion of the user's 105 design manipulations of the selected form, the user 105 may click the reset button 538 to erase all edits, or the user 105 may click the save button 539 to save all edits to the selected form.

Similarly, the user may design application screens to display graphs, statistical figures, maps, etc. FIG. 5D illustrate an example graph design screen 552 of some embodiments. As shown, the graph design screen 552 includes a graph selection drop box 553, a template selection drop box 554, a graph type selection drop box 555, an X axis value drop box 556 and X axis label drop box 557, a Y axis value drop box 558 and Y axis label drop boxes 559, an options button 560, a reset button 561, and a save button 562. In addition, the graph design screen 552 includes a preview panel 563 comprising the preview of the user selected graphs 564.

In some embodiments, the user 105 may create a new graph or select an existing graph to edit using the graph selection drop box 553. The user 105 may then select a template from the list of templates of the template selection drop box 554 to provide the data fields which will be used as data sources of the selected graph. The user 105 may then proceed to define the value comprising the data to be illustrated by the selected graph using, for example in the case of a two dimensional graph, the X axis value drop box 556 and the Y axis value drop box 558, and the X axis label drop box 557 and the Y axis label drop box 559. The preview panel 563 may then display a preview of the selected graph types based on the user's 105 edits to the X axis and Y axis values. As shown, the user 105 selected two types of graphs to be presented by the selected graph screen, a bar graph and a pie-chart graph 564. As mentioned, upon the conclusion of the user's 105 manipulations of the selected graph, the user 105 may click the reset button 561 to disregard all unsaved edits to the selected graph, or may click the save button 562 to save all current edits to the selected graph.

At the conclusion of all user 105 manipulations to the desired UI selectable items presented by the GUI, the user 105 may instruct the application creation system 102 to generate a meta-application based solely on the complete set of the user's 105 manipulations of the UI selectable items, as in step 315. In some embodiments, the communication manager 200 receives the user's 105 command to generate the meta-application through the user interface module 215. The communication manager 200 will then route this command to the meta-application generation module 240, which will commence in generating the meta-application based solely on the user's 105 manipulations of the UI selectable items. After the generation of the meta-application is completed, the communication manager 200 may store the newly generated meta-application in the database 210.

The user 105 may also instruct the application creation system 102 to translate the meta-application to compilable code 230 to be deployed and be made specific to at least one database system 210, as in step 320. In some embodiments, the user 105 will send a command to the user interface module 215 to translate a meta-application. The user interface module 215 will relay the command to the communication manager 200, which will retrieve the meta-application in question from the database 210 and will transmit it to the translation module 205. The translation module 205 will send back a request for more information regarding at least one specific database systems that may be associated with the target compilable code 230. Thereupon, the communication manager 200 may request this information from the user 105 through the user interface module 215.

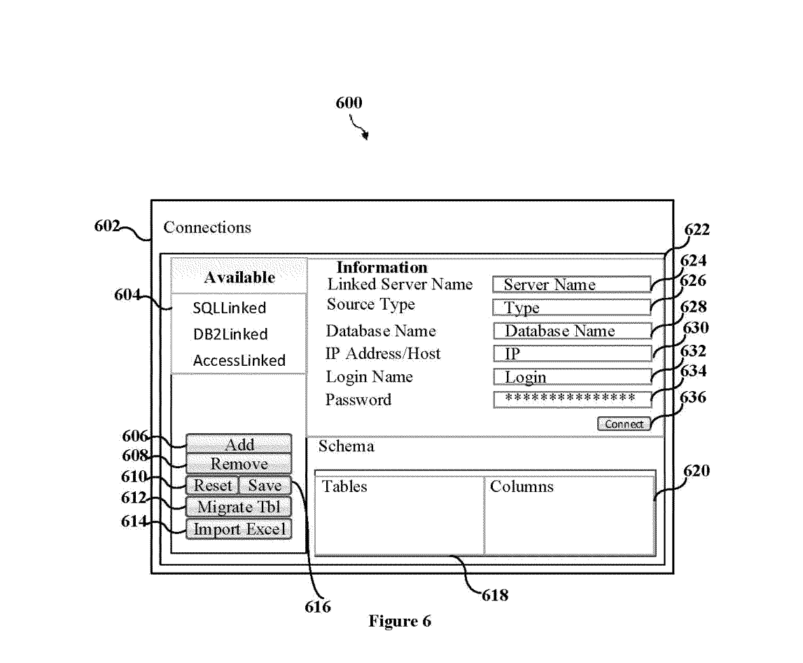

In some embodiments, the user 105 will be presented with a database connections configuration screen to associate the complilable code of the created software application to specific database systems. FIG. 6, illustrates an example database system connection screen 600 of some embodiments. As shown the database system connection screen 600 includes a connections panel 602 comprising a set of database systems 604 available to be connected with a compilable code (e.g. Microsoft® SQL database, DB2®, database, Oracle® database, SAP® database system, etc.) The connections panel 602 also comprises an add button 606, a remove button 608, a reset button 610, a save button 616, a migrate table button 612, an import excel button 614, a connection information panel 622, and a schema panel 618. The connection information panel includes a server name text field 624, a source type text field 626, a database name text field 628, an Internet Protocol (IP) address text field 630, a login name text field 632, a password text field 634, and a connect button 636.

In some embodiments, the user 105 may choose one of the available database systems sources 604 thereupon the connection information panel 622 will display the necessary fields to connect to the selected database system source. The user 105 may proceed to input the database system information, such as the server name, database name, IP address, login name, and password in the corresponding text fields (624, 626, 628, 630, 632, and 634), in some embodiments. The user 105 may then click the connect button 636 to verify connectivity to the specific database system, and to begin linking specific tables and columns of the specified database system.

For example, upon connecting to a Microsoft® SQL database, the schema panel 618 will display a listing of the database tables in the database table selection box 619. Next, the user 105 will select on or more of the displayed database tables, thus a listing of the tables' corresponding columns will be presented in the database columns selection box 620.

Upon verifying connectivity to the selected database name, the user 105 may click the add button 606 to add the database system connection to the compilable code. The user 105 may also remove database system connections already connected to the compilable code by selecting the connection from the available database systems 604 and clicking the remove button 608. During the process of setting up a specific database system connection, the user 105 may also have the option of erasing all unsaved configurations by clicking the reset button 610. Additionally, the user 105 may save all configurations to the current database system connection by clicking the save button 616. In some embodiments, the user 105 may also be able to migrate the data of certain tables of the selected database by clicking the migrate table button 612, or import data from external sources (e.g. excel, Microsoft® Access Database, etc.) by clicking the Import Excel button 614.

The produced compilable code 230 that connects to at least one specific database system 235 may then be deployed on a server. The compilable code 230 may be directly integrated with the application creation system 102 in some embodiment, or may be deployed on a server that is physical removed from the application creation system 102, and may connect to the application creation system 102 over a LAN, WAN, or the internet. In some embodiments, where the compilable code 230 is deployed on separate server, the communication manager 200 may deploy the compilable code 230 using the network interface 220.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A method of creating an enterprise software application, comprising:
providing a graphical user interface (GUI) comprising a plurality of user interface (UI) selectable items through a display;
manipulating the UI selectable items on the GUI to generate a meta-application, which accesses a database but which is both database systems agnostic and platform agnostic; and
translating the meta-application to compilable code that is database systems specific.

2. The method of claim 1, wherein the step of generating the meta-application comprises:
defining a business logic solely based on the manipulating of the UI selectable items; and
expressing the business logic in a meta-language.

3. The method of claim 2, wherein the compilable code is translated without compiling the meta-language into an object code.

4. The method of claim 1, wherein the compilable code is a first compilable code that is specific to a first database system, wherein the method further comprises translating the meta-application into a second compilable code that is specific to a second different database system.

5. The method of claim 1, wherein the compilable code is a first compilable code that is specific to a first platform, wherein the method further comprises translating the meta-application into a second compilable code that is specific to a second different platform.

6. The method of claim 1, further comprising compiling the translated code into an object code.

7. The method of claim 1, wherein the step of manipulating comprises selecting one of the pluralities of UI selectable items.

8. The method of claim 1, wherein the step of manipulating comprises selecting an initial location on the GUI for one of the plurality of UI selectable items.

9. The method of claim 8, wherein the step of manipulating comprises moving the UI selectable item from the initial location to a different location on the GUI.

10. The method of claim 1, wherein the compilable code directs a set of database actions.

11. The method of claim 10, wherein the set of database actions comprises inserting new data into a database system.

12. The method of claim 10, wherein the set of database actions comprises retrieving data from a database system and performing a calculation on the retrieved data.

13. The method of claim 1, wherein the plurality of UI selectable items comprises a menu for receiving a selection of an event, a menu for receiving a selection of an action item, and a UI selectable item for making an association between the event and the action item.

14. The method of claim 1, wherein the step of translating the meta-application comprises receiving information indicating a specific database system.

15. A system for creating an enterprise software application, comprising:
a graphical user interface (GUI) configured to (i) present a plurality of user interface (UI) selectable items through a display and (ii) receive manipulations of the plurality of UI selectable items; and
an application engine configured to (i) generate, based on the received manipulations of the plurality of UI selectable items, a meta-application that accesses a database but that is both database systems agnostic and platform agnostic and (ii) translate the meta-application to compilable code that is database systems specific.

16. The system of claim 15, wherein the application engine is further configured to generate the meta-application by defining a business logic solely based on the manipulations of the UI selectable items and expressing the business logic in a meta-language.

17. The system of claim 15, wherein the compilable code is translated without compiling the meta-language into an object code.

18. The system of claim 15, wherein the compilable code is a first compilable code that is specific to a first database system, wherein the application engine is further configured to translate the meta-application into a second compilable code that is specific to a second different database system.

19. The method of claim 15, wherein the compilable code is a first compilable code that is specific to a first platform, wherein the application engine is further configured to translate the meta-application into a second compilable code that is specific to a second different platform.

20. The method of claim 15, wherein the compilable code directs a set of database actions.
